(19) United States
(12) Patent Application Publication
(10) Pub. No.: US 2003/0204549 A1
(43) Pub. Date: Oct. 30, 2003

(54) OPERATING SYSTEM FOR HANDLING DYNAMIC AND STATIC TASKS

(76) Inventors: WOLFGANG EIBACH, HOLZGERLINGEN (DE); MATTHIAS GRUETZNER, SCHOENAICH (DE)

Correspondence Address: STEPHEN C KAUFMAN, IBM CORPORATION, INTELLECTUAL PROPERTY LAW T J WATSON, RES CENTER P O BOX 218, YORKTOWN HGTS, NY, 10598

(21) Appl. No.: 09/354,375

(22) Filed: Jul. 14, 1999

(30) Foreign Application Priority Data
Oct. 22, 1998 (EP) 98 119 992.0

(51) Int. Cl. G06F 15/163; G06F 9/54; G06F 9/00

(52) U.S. Cl. 709/102

(57) ABSTRACT

The present application provides an operating system for handling dynamic tasks, especially telematic functions in a motor vehicle, wherein said tasks are created, terminated and subsequently destroyed, characterized in that said operating system is also able to handle static tasks by creating, terminating and subsequently putting said tasks into a suspended state, so that said tasks can be reactivated, if required, without rebuilding any of their resources.

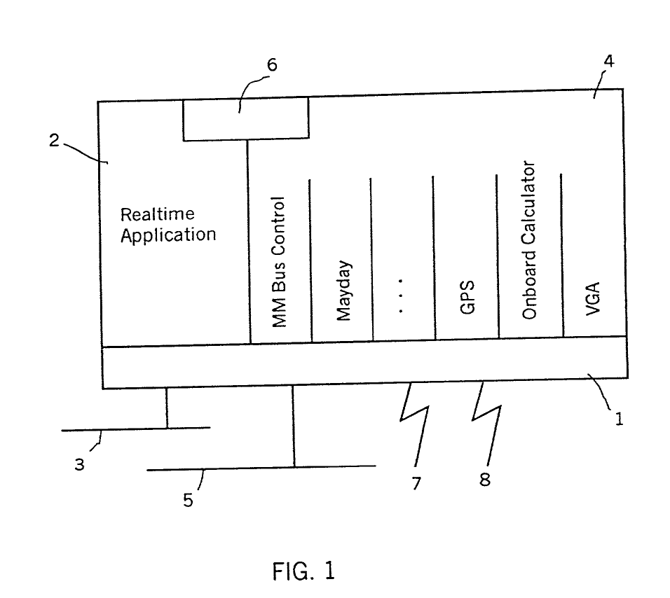

The present invention in general relates to operating systems and, more specifically, to operating systems for handling dynamic and static tasks. Still more specifically, the present invention relates to such operating systems that handle functions in a motor vehicle.

The automotive industry has a long tradition in mechanical/electrical technologies and their engineering. Since a few years, however, the technical community can observe a transition from the classical techniques to electronics, particularly for control functions.

Speaking of electronics meant until recently mainly micro controllers, i.e., uncoupled and fixed-programmed hardware developed for very dedicated functions. Market demands, such as car weight reduction, development/production cost reduction, function reliability increase, diagnostics improvement, support of completely new and more complex functions are forcing the automotive manufactureres to look for drastic improvements during the development cycle and production phase, and for new solutions in technology and architectures of the vehicles functions themselves.

The last years show a dramatic increase in complexity of the single components as well as of the car as a system. This is due to the growing number of components, their high interaction rates, the consumers' demand for excellent reliability, usability and safety and so on. The traditional engineering processes cannot meet these new requirements effectively with reasonable costs. New development concepts and better engineering methods, together with highly efficient tools are required.

The first step of improving electronic functions in motor vehicles was the interconnection of in-car controllers by field busses like CAN or J1850, etc. The next step is adding telematics function like emergency calls, breakdown calls, traffic info, etc. Emerging standards in this field are GATS (Global Automotive Technical Standard) and WAP (Wireless Application Protocol), enabling e-business for vehicles.

So far these functions are executed on separate hardware platforms, one for the classical car functions including interconnection software, and one for the telematic functions. This is simply determined by the different operating systems used, a static one for the classical car functions like seat-, window-, climate-, gearbox- and motor control, and a dynamic one for telematic functions. This approach is well suited for luxury cars but obviously not a cost optimized setup for the mass market.

One operating system suitable to carry out static functions is , e.g., OSEK (Offene Systeme und deren Elektronik im Kraftfahrzeug) OS APIs (Application Program Interface). Dynamic functions can, e.g., be handled by POSIX (Portable operating System Interface). However, the skilled worker will be aware of the fact that these operating systems are not the only ones that are able to carry out respective tasks. Therefore, the present invention is not restricted to these operating systems but can be carried out with every operating system being able to handle static or dynamic functions.

When static OSEK APIs dynamic POSIX functions are required on one platform, current implementations solve this requirement by adding an OSEK layer on top of the available RTOS (Real Time Operating System). This, however, has many disadvantages, e.g., a bad performance which most times is not acceptable. In addition, some of the OSEK APIs cannot be mapped onto POSIX APIs because the POSIX kernel does not support them, leading to a not fully compliant implementation. This solution is offered for debug platforms, where the performance is normally sufficient and compliance not the issue. However, this approach cannot be used for real runtime environments, especially in a vehicle, where special tasks, e.g., break control, must, under all circumstances, be processed in a hard real time environment.

It is therefore an object of the present invention to provide a single platform where both functional domains, static and dynamic, are integrated.

It is a further object of the present invention to provide an operating system that is able to handle static as well as dynamic tasks.

These and other objects are achieved by the operating system of claim 1 and the method of claim 3.

The present invention provides a solution for the coexistence for both functional domains, static and dynamic, on one single platform.

To provide such a solution an RTOS is put on a processor platform. This operating system handles all the system resources and especially must support an interface being able to communicate with the dynamic world, like the POSIX interface.

To combine these dynamic functions with the static OSEK world, the proposed solution uses a kernel extension, thus adding basic functions to the library of the RTOS. This kernel extension overcomes the performance bottleneck of today's layered approach. In addition, it allows for a full, OSEK standard compliant operating system, supporting all APIS.

The major kernel change is in the task handling. In a dynamic system like POSIX, a task and all its resources are destroyed when the task is terminated. When the same task has to be reestablished, every resource, e.g., memory, stack, etc., has to be created again. This leads to a long time required for this process if handled by a layer emulating an OSEK static system.

The kernel extension proposed herein changes the task handling for the static OSEK tasks and leaves the task handling for the POSIX world untouched. The new mechanism just puts an OSEK task into a suspended state, leaving all its resources in the memory when the task is terminated. In this suspended state, the task does not need any processor resources and will not affect the overall system performance. When the task is activated again, it is just initialized, i.e., changing it from its suspended mode into the active mode. No rebuilding of any of its resources is required, leading to the required immediate processing.

Additional priority management for task and process execution must be available to support real time requirements. However, the skilled worker will readily know how to achieve this so that there is no need to explain in any great detail.

By this proposal a low cost system is given which supports in-car applications and off-car applications, and it thereby enables e-business for the automotive mass market.

The invention will hereinafter be explained in more detail in connection with the accompanying drawing.

With the introduction of 32 bit processors in the automotive arena new options for setting up systems for classical car functions and telematic functions are given. Especially integration of both functional domains on one platform is possible.

Referring now to the FIGURE, the kernel 1 of the POSIX operating system is extended by OSEK API functions. The new world of OSEK task management is implemented, resulting in an excellent performance, i.e., start of new tasks or tasks which were suspended, allowing for hard real time performance.

On the static portion 2 of the system the typical in-car applications are executed, an access to one or more CAN busses 3 is a prerequisite. Applications are written against the OSEK APIs. On the dynamic portion 4 the telematic functions (like mayday functions, breakdown functions, GPS, onboard calculator, VGA, etc.; it has to be noted that this listing is not limiting and that a skilled worker can think of many additional functions that can be included here) are executed, access to a multimedia bus 5 is typical for this set of applications, so are GPS 7 and GSM 8 applications. These applications make use of the POSIX APIS. The need of information exchange between the two worlds is done by a shared memory 6 providing the necessary safety. In any case, only staticly defined requests can be executed, no direct manipulation of code on the static address space is possible.

1. operating system for handling dynamic tasks, especially telematic functions in a motor vehicle, wherein said tasks are created, terminated and subsequently destroyed,
characterized in that
said operating system is also able to handle static tasks by creating, terminating and subsequently putting said tasks into a suspended state, so that said tasks can be reactivated, if required, without rebuilding any of their resources.

2. operating system according to claim 1, characterized in that said suspended state is realized by extending the kernel of the operating system for handling dynamic tasks.

3. Method of handling dynamic and static tasks, especially functions in a motor vehicle,
charcaterized in that
said static tasks, after termination, are put into a suspended state, so that said tasks can be reactivated, if required, without rebuilding any of their resources.
